(19) United States
(12) Patent Application Publication
(10) Pub. No.: US 2012/0040542 A1
(43) Pub. Date: Feb. 16, 2012

(54) CABLE CONNECTOR ASSEMBLY WITH A PRINTED CIRCUIT BOARD TO CHANGE ARRANGEMENT OF WIRES

(75) Inventors: NAI-HAO CAO, Shen Zhen (CN); SHAO-KUI FENG, Shen Zhen (CN); ZI-FEI LIU, Shen Zhen (CN); YONG-JUN CHEN, Shen Zhen (CN); JIN-ZHI CHEN, Shen Zhen (CN); SHOU-TSUNG LAI, New Taipei (TW)

(73) Assignee: HON HAI PRECISION INDUSTRY CO., LTD., New Taipei (TW)

(21) Appl. No.: 13/208,357

(22) Filed: Aug. 12, 2011

(30) Foreign Application Priority Data
Aug. 13, 2010 (CN) 201020291412.2

(51) Int. Cl. H01R 12/72

(52) U.S. Cl. 439/83

(57) ABSTRACT

An cable connector assembly (100), comprising an insulative housing (1) defining a plurality of cavities (16), a plurality of contacts (2) received in the corresponding cavities, a plurality of wires (4) electrically connected with the contacts (2), and a printed circuit board (3) assembled to a back end of the insulative housing. The printed circuit board defines a first conductive portion (32) electrically connected with the contacts and a second conductive portion (33) electrically connected with the wires, the wires are located in front of the printed circuit board and soldered to the second conductive portion, and the wires are arranged to extend forwards along a mating direction and perpendicular to the printed circuit board.

### BACKGROUND OF THE INVENTION

1. Field of the Invention

The present invention generally relates to a cable connector assembly, and more particularly to a cable connector assembly used in an electronic equipment.

2. Description of Related Art

Cable connector assemblies are widely used in electronic equipment, U.S. Pat. No. 7,112,105B2 discloses a cable connector assembly comprising an insulated housing with a plurality of channels, a plurality of contacts received in the insulated housing, and a plurality of wires held in tail portions of the contacts. The wires are retained in the corresponding tail portions and extending rearwards along a mating direction. However, the cable connector assembly will have a larger length along the mating direction as the wires extending rearwards, and the inner space of the electronic equipment is decreased gradually with the development of electronics, so the arrangement of the wires stated above cannot meet the requirements. And in some cases, the wires are bent to make the length of the cable connector assembly be smaller finitely, and the contacts may be deflected in the insulated housing. Thus, particular wire arrangement manner is needed to satisfy the current demands.

Hence, it is desirable to have an improved structure to overcome the above-mentioned disadvantages of the prior art.

### BRIEF SUMMARY OF THE INVENTION

Accordingly, the object of the present invention is to provide a cable connector assembly with a printed circuit board to make the wires extending forwards along a mating direction, thus the cable connector assembly can have a smaller length and contacts can be stable in an insulative housing.

In order to achieve the above-mentioned object, a cable connector assembly in accordance with the present invention comprises an insulative housing defining a plurality of cavities, a plurality of contacts received in the corresponding cavities, a plurality of wires electrically connected with the contacts, and a printed circuit board assembled to a back end of the insulative housing. The printed circuit board defines a first conductive portion electrically connected with the contacts and a second conductive portion electrically connected with the wires, the wires are located in front of the printed circuit board and soldered to the second conductive portion, and the wires are arranged to extend forwards along a mating direction and perpendicular to the printed circuit board.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled, perspective view of a cable connector assembly in accordance with the present invention;

FIG. 2 is a view similar to FIG. 1, but viewed from a different aspect;

FIG. 3 is a partially assembled, perspective view of the cable connector assembly shown in FIG. 1;

FIG. 4 is a view similar to FIG. 3, but viewed from a different aspect;

FIG. 5 is an exploded, perspective view of the cable connector assembly shown in FIG. 1; and

FIG. 6 is a view similar to FIG. 5, but viewed from a different aspect.

### DETAILED DESCRIPTION OF THE INVENTION

Reference will now be made to the drawing figures to describe the present invention in detail.

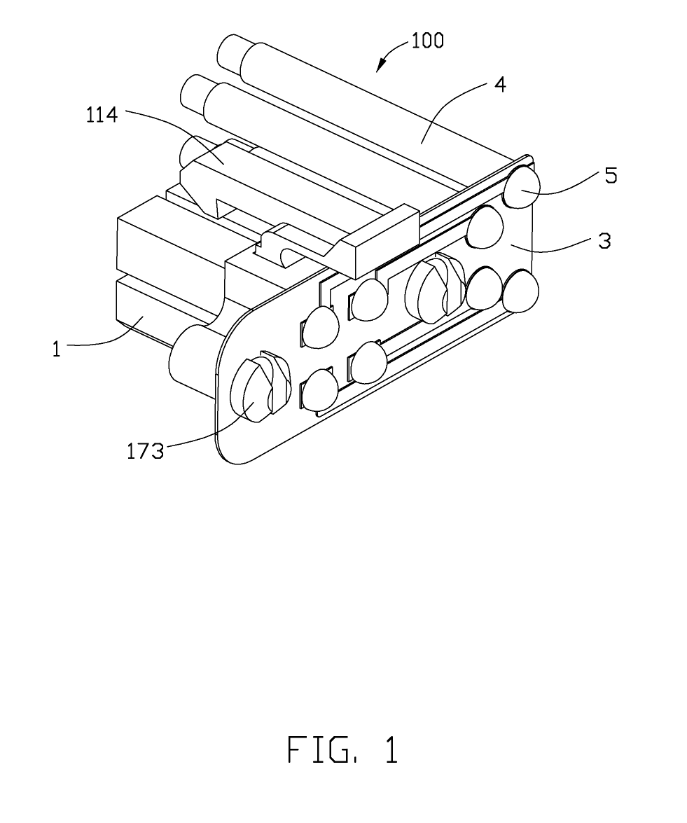

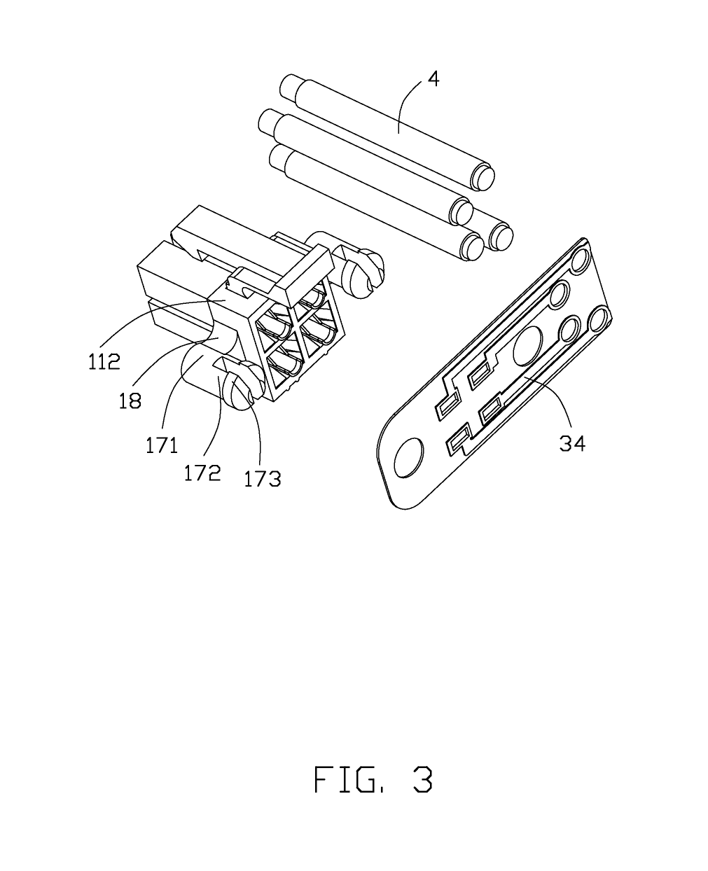

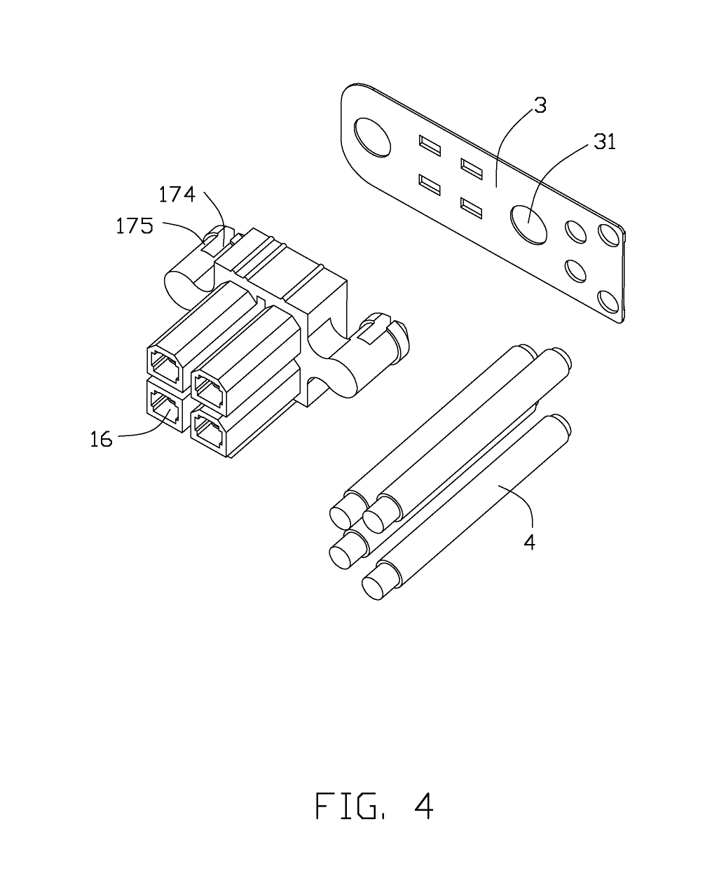

Referring to FIGS. 1-5, a cable connector assembly 100 made in accordance with the present invention comprises an insulative housing 1, a plurality of contacts 2 retained in the insulative housing 1, a plurality of wires 4 electrically connected with the contacts 2, and a printed circuit board 3 mounted to the insulative housing 1, the printed circuit board 3 is perpendicular to the insulative housing 1.

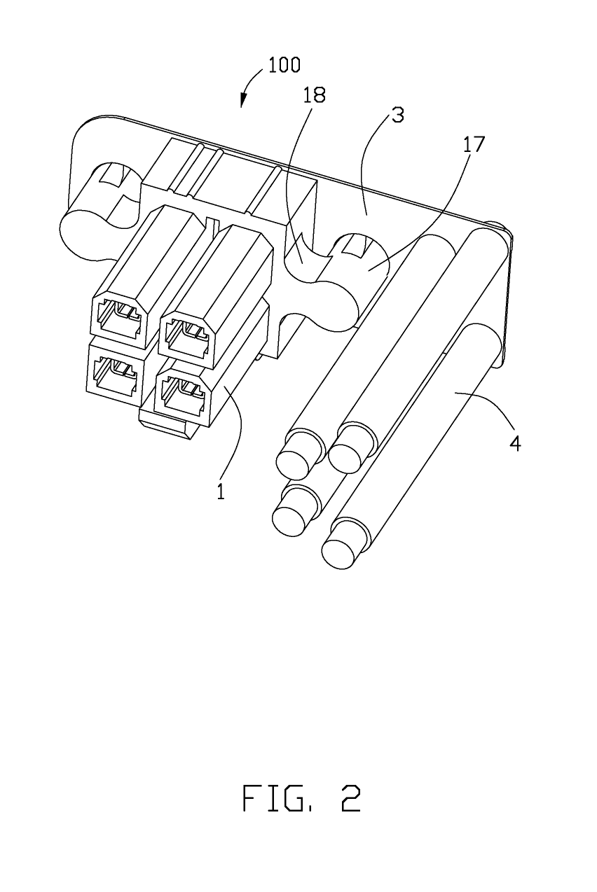

Referring to FIGS. 2-6, the insulative housing 1 is configured with T shape, and comprises a base portion 11 and a plurality of mating posts 13 extending forwards from a front surface 12 of the base portion 11 along a mating direction. The mating posts 13 are divided into two groups spaced apart from each other. The base portion 11 defines a connecting surface 14 opposite to the front surface 12, and the mating posts 13 have a same mating surface 15, the mating surface 15 is parallel to the front surface 12 and in front of the front surface 12. The insulative housing 1 defines a plurality of cavities 16 penetrating through the mating posts 13 and the base portion 11 from the mating surface 15 to the connecting surface 14. The base portion 11 has a latch portion 114 defined on a top surface 112 thereof, and the latch portion 114 is used for engaging with a locking mechanism of a complementary connector (not shown) to achieve a secure engagement between the cable connector assembly 100 and the complementary connector.

A pair of mounting portions 17 are defined on lateral sides of the insulative housing 1, and a shoulder 18 is disposed between each mounting portion 17 and the base portion 11, that is to say, each mounting portion 17 is connecting with the base portion 11 via the shoulder 18 indirectly. The mounting portions 17 are vertical to the shoulders 18, and each mounting portion 17 includes a column 171 and a fixing portion 172 extending rearwards from the column 171, an expansion 173 is extending outwards from a back end of the fixing portion 172. A front segment of the expansion 173 has a larger diameter than the fixing portion 172, and a rear segment of the expansion 173 is tapered. A cutout 174 is recessed from a back end of the expansion 173 to the fixing portion 172, therefore a pair of deformable pieces 175 are formed. In other alternative embodiments of the present invention, the mounting portions 17 can be defined on other positions of the base portion 11 and with other configurations.

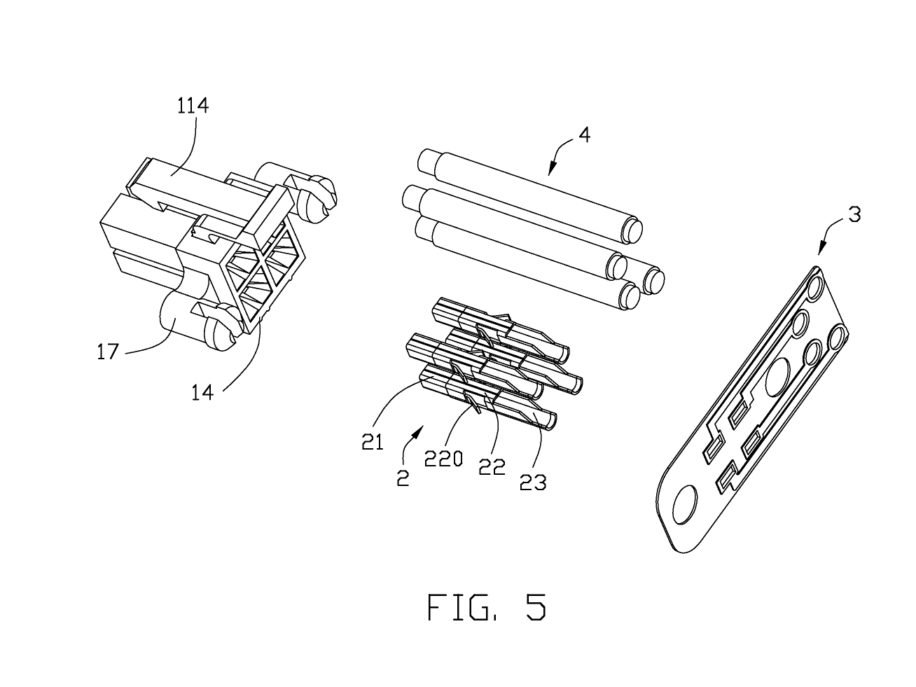

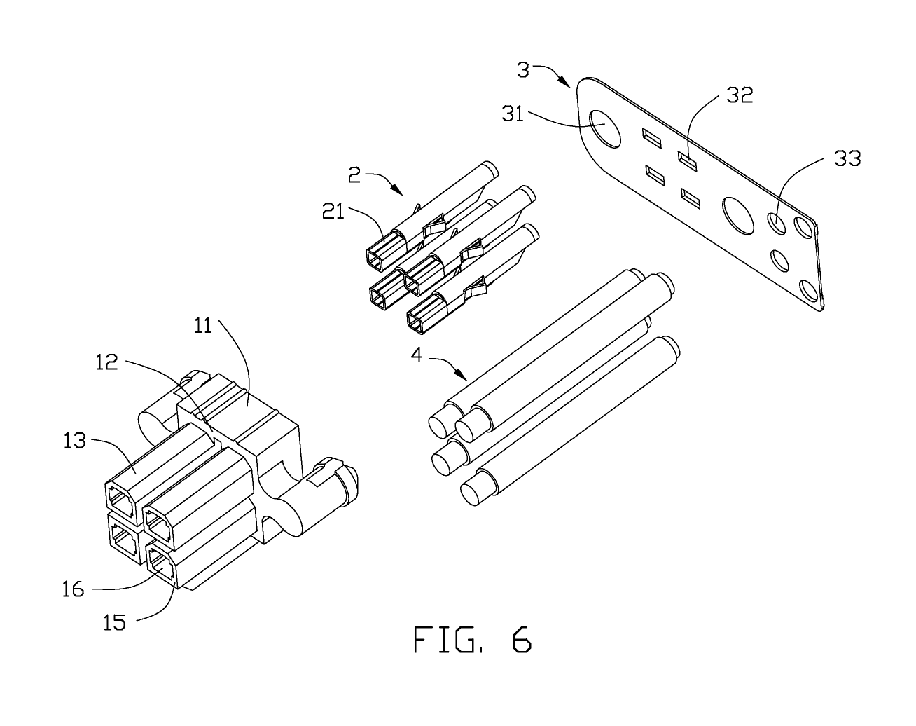

Referring to FIGS. 5-6, the contacts 2 are arranged with an upper row and a lower row, and received in the corresponding cavities 16 of the insulative housing 1. Each contact 2 comprises a contacting portion 21, a tail portion 23 and a retaining portion 22 connecting the contacting portion 21 and the tail portion 23. Each retaining portion 22 defines a pair of barbs 220 on both sides thereof. The barbs 220 are interferentially cooperating with inner walls of the cavities 16 under the condition that the contacts 2 received in the cavities 16. The contacting portions 21 are exposed in the cavities 16 and neighboring to the mating surface 15.

The printed circuit board 3 is rectangular, and defines a pair of receiving holes 31, a first conductive portion connected with the contacts 2, and a second conductive portion connected with the wires 4. In the preferred embodiment of the present invention, a plurality of first conductive holes 32 are served as the first conductive portion, and a number of second conductive holes 33 are served as the second conductive portion. The printed circuit board 3 defines a plurality of conductive traces 34 electrically connected the first conductive holes 32 and the second conductive holes 33. The receiving holes 31 are located on both sides of the first conductive holes 32, and aligning with the corresponding mounting portions 17 of the insulative housing 1.

In assembly, the contacts 2 are inserted into the cavities 16 of the insulative housing 1, then the printed circuit board 3 is assembled to the connecting surface 14 of the insulative housing 1, and the mounting portions 17 are inserted into the corresponding receiving holes 31, the expansions 173 are extending through the receiving holes 31 and beyond a rear surface of the printed circuit board 3, therefore the printed circuit board 3 is locked with the insulative housing 1. The mounting portions 17 moves rearwards and the deformable pieces 175 might splay outwards along a radial direction after the deformable pieces 175 extending through the receiving holes 31, and the deformable pieces 175 is located behind the printed circuit board 3 to prevent the printed circuit board 3 moving backwards relative to the insulative housing 1.

Additionally, the tail portions 23 of the contacts 2 are inserted into the corresponding first conductive holes 32 of the printed circuit board 3, and soldered in the first conductive holes 32 via solder 5. The wires 4 are disposed in front of the printed circuit board 3, inner conductors (not labeled) of the wires 4 are inserted into the second conductive holes 33 of the printed circuit board 3 and soldered in the second conductive holes 33.

The wires 4 of the cable connector assembly 100 in the present invention are arranged to extend forwards along the mating direction and perpendicular to the printed circuit board 3, therefore the cable connector assembly 100 can have a smaller length along the mating direction, and the contacts 2 can be prevent deflecting in the cavities 16 while the wires 4 not need bend.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector assembly, comprising:
an insulative housing defining a plurality of cavities;
a plurality of contacts received in the corresponding cavities;
a plurality of wires electrically connected with the contacts; and
a printed circuit board assembled to a back end of the insulative housing; wherein
the printed circuit board defines a first conductive portion electrically connected with the contacts and a second conductive portion electrically connected with the wires, the wires are located in front of the printed circuit board and soldered to the second conductive portion, and the wires are arranged to extend forwards along a mating direction and perpendicular to the printed circuit board.

2. The cable connector assembly as claimed in claim 1, wherein the printed circuit board defines a pair of receiving holes located on both sides of the first conductive portion, and the insulative housing defines a pair of mounting portions assembled into the corresponding receiving holes.

3. The cable connector assembly as claimed in claim 2, wherein the insulative housing defines a base portion and a shoulder disposed between each mounting portion and the base portion.

4. The cable connector assembly as claimed in claim 3, wherein the mounting portions are vertical to the shoulders.

5. The cable connector assembly as claimed in claim 2, wherein each mounting portion includes a column and a fixing portion extending rearwards from the column, an expansion is extending outwards from a back end of the fixing portion, and a front segment of the expansion has a larger diameter than the fixing portion.

6. The cable connector assembly as claimed in claim 5, wherein the expansions are extending through the receiving holes 31 and beyond a rear surface of the printed circuit board 3.

7. The cable connector assembly as claimed in claim 5, wherein a rear segment of the expansion is tapered.

8. The cable connector assembly as claimed in claim 5, wherein a cutout is recessed from a back end of the expansion to the fixing portion, therefore a pair of deformable pieces are formed.

9. The cable connector assembly as claimed in claim 2, wherein a plurality of first conductive holes are served as the first conductive portion, and a number of second conductive holes are served as the second conductive portion, the printed circuit board defines a plurality of conductive traces electrically connected the first conductive holes and the second conductive holes.

10. The cable connector assembly as claimed in claim 9, wherein the printed circuit board is vertical to the insulative housing.

11. The cable connector assembly as claimed in claim 10, wherein the insulative housing comprises a base portion and a plurality of mating posts extending forwards from a front surface of the base portion along the mating direction.

12. The cable connector assembly as claimed in claim 11, wherein the mating posts are divided into two rows spaced apart from each other.

13. The cable connector assembly as claimed in claim 10, wherein the insulative housing has a latch portion on a top surface thereof, and the latch portion is used for engaging with a locking mechanism of a complementary connector.

14. An electrical cable connector assembly comprising:
a printed circuit board defining opposite first and second surface,
a first region and a second region formed on the first surface and spaced from each other while electrically connected via traces on other printed circuit board;
an electrical connector having therein a plurality of contacts which are mechanically and electrically connected to the first region and defining a mating port communicating with an exterior forwardly; and
a plurality of wires electrically and mechanically connected to the second region and extend forwardly for connecting to another electronic part.

15. The electrical cable connector assembly as claimed in claim 14 wherein the connector includes an insulative housing equipped with a securing device for fastening to the printed circuit board, and said securing device is located between the first region and the second region.

16. The electrical cable connector assembly as claimed in claim 14 wherein the housing is further equipped with a deflectable latch having rear end extending rearwardly beyond the second surface.
